(19) United States
(12) Patent Application Publication
(10) Pub. No.: US 2025/0121722 A1
(43) Pub. Date: Apr. 17, 2025

(54) METHOD FOR SUPPRESSING EMC DISTURBANCES IN A DC CHARGING STATION FOR ELECTRIC VEHICLES

(71) Applicant: Bender GmbH & Co. KG, Gruenberg (DE)

(72) Inventor: Winfried Moell, Laubach (DE)

(21) Appl. No.: 18/914,580

(22) Filed: Oct. 14, 2024

(30) Foreign Application Priority Data
Oct. 13, 2023 (DE) 10 2023 128 046.5

(51) Int. Cl. B60L 53/60; H02J 7/06

(52) U.S. Cl. CPC B60L 53/60; H02J 7/06; B60L 2210/42; H02J 2207/20

(57) ABSTRACT

A method for suppressing EMC disturbances in a DC charging station for electric vehicles with at least one converter circuit having semiconductor circuit breakers which are actuated via a pulse curve using a switching frequency. The method includes providing an alternating voltage from an AC power supply system; rectifying the alternating voltage in a DC intermediate voltage; and converting the DC intermediate voltage to a DC charging voltage, the switching frequency of the pulse curve being varied continuously or randomly for actuating the semiconductor circuit breakers. The method is applicable analogously for a charging device in an electric vehicle.

This document claims priority to German Patent Application No. 10 2023 128 046.5 filed on Oct. 13, 2023, the disclosure of which is incorporated by reference herein.

### TECHNICAL FIELD

The invention relates to a method for suppressing EMC disturbances in a DC charging station for electric vehicles, the DC charging station having at least one converter circuit having semiconductor circuit breakers which are actuated via a pulse curve using a switching frequency. In this context, an alternating voltage is provided by an AC power supply system; the alternating voltage is rectified in a DC intermediate voltage; and the DC intermediate voltage is converted to a DC charging voltage.

### BACKGROUND

With rising electric mobility, a sufficiently developed charging infrastructure is required by means of which the energy storage of battery-operated electric vehicles can be efficiently and electrically safely charged. With regards to a quick charge process, charging systems have therefore been conceptualized in which the alternating current provided by the public power supply system is converted in the electric vehicle to a direct current required for charging the battery. To further reduce the charging times, however, a high charging capacity of up to 300 kW and more is required, which can only be provided outside of the vehicle by DC charging stations because of the more sophisticated circuitry. The architecture of a DC charging station therefore has a (first) converter circuit in the form of an AC/DC rectifier. This DC intermediate voltage generated by the rectifier is converted to a DC charging voltage adapted for the battery of the vehicle to be charged in the range of a few 100 V to 1,000 V in another (second) converter circuit configured as a DC/DC converter (chopper converter).

The circuitry of the converter circuits—the AC/DC rectifier and the DC/DC converter—is based on semiconductor power electronics. In order to achieve the lowest possible residual ripple in the DC charging voltage, efforts are made to operate the semiconductor circuit breakers with the highest possible switching frequency and the highest possible edge steepness, a switching frequency having a fundamental frequency of 10 kHz to over 40 kHz, on which the pulse curve is based, corresponding to the state of the art. However, such a high-frequency pulse curve for actuating the semiconductor circuit breakers increases the switching losses and the EMC disturbance radiation, yet helps to reduce the power loss of an existing transformer. The overall power loss can therefore be kept low owing to high clocking and a large edge steepness, although this advantage comes at the cost of increased EMC disturbance radiation.

Although the introduction of wide-band-gap semiconductor materials, such as silicon carbide (SiC) and gallium nitride (GaN), in particular also reduces switching losses at higher switching frequencies, disturbance frequency components can lead to considerable EMC disturbances, which are transmitted via the charging device itself and the connection cable.

Measures to reduce these EMC disturbances are known from the state of the art in the field of switching power supplies. For instance, active and passive filters are used to reduce the disturbance level by converting the disturbance energy to heat. Depending on the level of disturbance, however, the disturbance suppression effort is very high and thus leads to reduced efficiency of the power electronics.

### SUMMARY

The object of the invention at hand is therefore based on developing a method for reducing EMC disturbances in a DC charging station for electric vehicles, which also increases the efficiency of providing a DC charging voltage and can be implemented cost-effectively.

This object is attained in conjunction with the features of the disclosed invention in that the switching frequency of the pulse curve for actuating the semiconductor circuit breakers is varied continuously and randomly.

The semiconductor circuit breakers are actuated via a pulse curve consisting of a rectangular pulse sequence having a fundamental oscillation (first harmonic) whose frequency (fundamental frequency) corresponds to the switching frequency. The pulse curve is therefore a periodic signal having a switching period (reciprocal of the switching frequency) and has a line spectrum as the result of a Fourier analysis. The line spectrum of the rectangular pulse sequence having a constant switching period shows spectral components at odd-numbered multiples of the fundamental frequency (Fourier coefficients of the harmonics). These power peaks act as disturbance levels and can therefore cause EMC disturbances.

According to the invention, the switching frequency is varied continuously and randomly. In the spectral view, the randomness of the frequency change results in a “smearing” of the spectral components in the direction of a more uniform power density spectrum of the thus modified pulse curve. This leads to a reduction in the disturbance level and results in greater EMC compatibility.

In a further embodiment, the switching frequency is varied via prolonging and/or reducing consecutive switching periods by a randomly determined delay time.

As a result of the continuous change in the period duration of consecutive switching periods with a randomly determined delay time, the pulse curve no longer has a strict periodicity. The pulse curve modulated in this manner shows a deliberately induced slight temporal fluctuation, the desired charging current remaining correctly set on average.

The prolonging (positive delay time) and the reducing (negative delay time) of the switching period results in a more uniform distribution of the power density spectrum compared to the (unmodulated) pulse-curve fundamental form, thus reducing the power peaks and hence the EMC disturbance level.

The switching period is randomly prolonged and reduced by adding a delay time (positive delay) and/or subtracting a delay time (negative delay) to/from the switching period of the pulse curve in unmodulated form.

Furthermore, the randomly determined delay time for prolonging and reducing the switching period can be generated by a random generator.

In order to achieve the randomness of the switching-period delay introduced to reduce the peaks of the power density spectrum, the delay time required for prolonging and reducing the switching period is determined by means of a random generator.

The random generator is preferably realized as a pseudorandom generator (PN generator).

The PN generator (pseudo-noise generator) generates a random sequence of words, each of which represents a-thus randomly determined-delay time. In fact, the sequence is not strictly random due to the limited storage capacity, but has a periodicity and fulfills the characteristics of a random sequence if the period length is long enough. The extent of the reduction in disturbance radiation is influenced by the bandwidth of the variation in the switching frequency and the period length of the PN sequence.

Furthermore, the switching frequency can also be varied by means of a randomly controlled digital signal generator.

As an alternative to varying the switching frequency by adding and/or subtracting the randomly determined delay time to/from the switching period, a (rectangular-wave) signal generator is implemented which, in conjunction with a random generator, continuously and randomly varies the fundamental frequency of the fundamental oscillation on which the pulse curve is based.

The digital signal generator preferably functions on the basis of the DDS method.

The direct digital synthesis (DDS) method can be used to generate the periodic pulse curve. This method has the advantage of good dynamic behavior with high temporal resolution so that the fundamental frequency of the pulse curve can be changed quickly even at high switching frequencies.

Advantageously, the method according to the invention is further applied in an analogous manner for a charging device in an electric vehicle, the charging device having at least one converter circuit having semiconductor circuit breakers which are actuated via a pulse curve using a switching frequency.

If the electric vehicle has an on-board charging device (on-board charger), which rectifies the alternating voltage provided by the AC power supply system to a DC intermediary voltage and then converts this to a DC charging voltage, the method according to the invention can also be implemented in this charging device.

In summary, the method according to the invention effectively suppresses EMC disturbances in a DC charging station or in an on-board charging device, while at the same time reducing costs and installation space by foregoing filter devices. When using SiC and GaN semiconductors having actuation via high-frequency pulse curves, the power loss and the residual ripple of the DC charging voltage can be reduced. The use of components available on the market (random generator) enables a solution which is simple in terms of circuitry and can also be retrofitted.

### BRIEF DESCRIPTION OF THE DRAWINGS

Further advantageous embodiment features can be derived from the following descriptions and the drawings, which illustrate a preferred embodiment of the invention by means of examples.

FIG. 1 shows an architecture of a DC charging system.

FIG. 2 shows a pulse curve in fundamental form.

FIG. 3 shows the Fourier spectrum of the pulse-curve fundamental form from FIG. 2.

FIG. 4 shows a periodically modulated pulse curve according to the invention.

FIG. 5 shows the Fourier spectrum of the periodically modulated pulse curve from FIG. 4.

FIG. 6 schematically shows the generation of the periodically modulated pulse curve.

### DETAILED DESCRIPTION

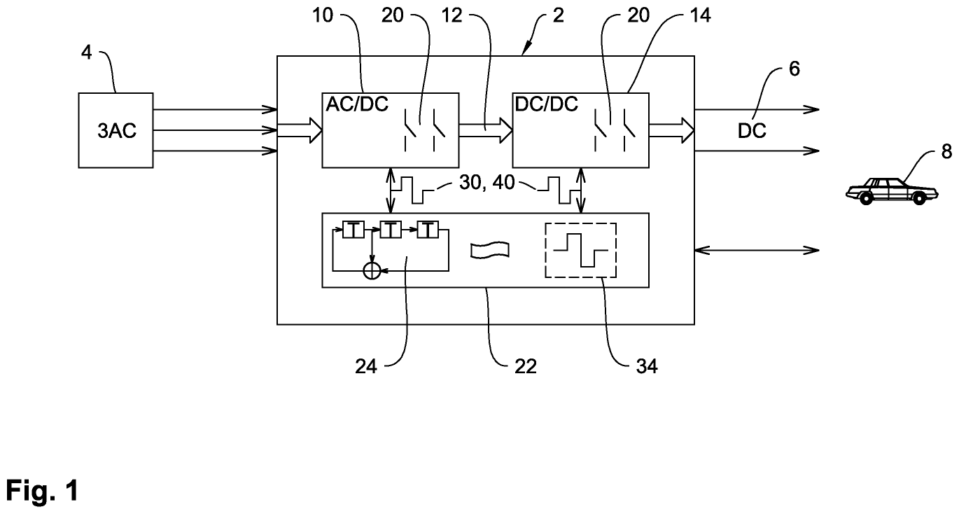

FIG. 1 shows an architecture of a DC charging system. A DC charging station 2 is supplied by a 3AC power supply system 4 and generates a DC charging voltage 6 for charging an energy storage of an electric vehicle 8.

The DC charging station 2 comprises an AC/DC rectifier 10 for rectifying an alternating voltage provided by the 3AC power supply system 4 to a DC intermediary voltage 12. The DC intermediate voltage 12 is converted to the DC charging voltage 6 adapted to the energy storage of the electric vehicle 8 by means of a DC/DC converter 14. Both the first converter circuit designed as an AC/DC rectifier 10 and the second converter circuit in the form of the DC/DC converter 14 have semiconductor circuit breakers 20, which are each actuated by means of an individual pulse curve 30, 40. The respective pulse curve 30, 40 is generated by a control unit 22.

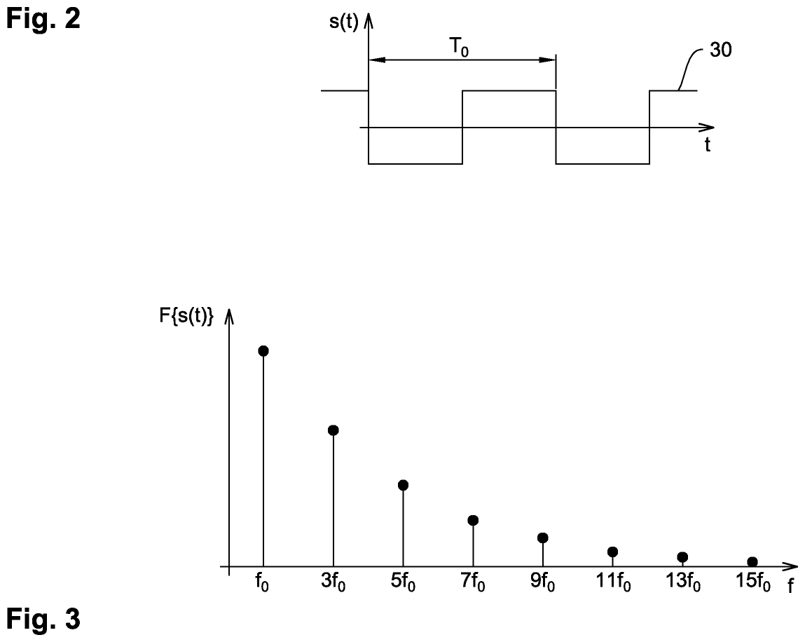

FIG. 2 shows the fundamental form of a pulse curve 30, which is generated, for example, by an oscillator circuit as a clock generator. The pulse curve 30 consists of a periodic rectangular pulse sequence with the switching period T₀. The fundamental frequency f₀ (reciprocal of the switching period T₀) of the pulse curve 30 corresponds to the switching frequency fₛ, by means of which the semiconductor circuit breakers 20 are actuated.

The Fourier spectrum F {s (t)} in FIG. 3 of the periodic pulse-curve fundamental form 30 from FIG. 2 is reflected in a line spectrum which consists of spectral components at points of odd-numbered multiples of the fundamental frequency f₀.

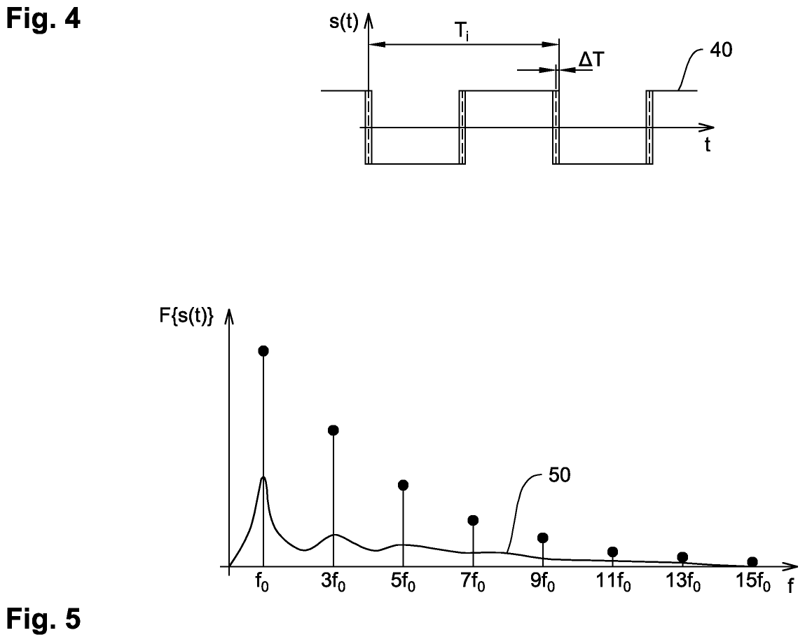

FIG. 4 shows a periodically modulated pulse curve 40. A randomly controlled prolonging and/or reducing of consecutive switching periods T₀ of the pulse-curve fundamental form 30 by means of a positive or negative delay time ΔT results in longer and/or shorter switching periods Tᵢ. This causes the fundamental frequency f₀ of the periodically modulated pulse curve 40, which actuates the semiconductor circuit breakers 20, to vary in accordance with the switching frequency fₛ.

As FIG. 5 shows, this prolonging and reducing of consecutive switching periods T₀ of the pulse-curve fundamental form 30 results in a more uniform distribution 50 of the power density of the periodically modulated pulse curve 40 in the spectral representation and thus causes a reduction in the EMC disturbance components.

For example, the fundamental frequency f₀=40 kHz (switching frequency fₛ) of a power converter in the DC charging station 2 can be varied by +/−500 Hz, which corresponds to periodically modulated switching periods Tᵢ of 24.69 μs to 25.32 μs and a time difference between the shortest and longest switching period Tᵢ of 625 ns.

The switching period T₀ is changed dynamically from switching period to switching period with a sequence of randomly determined delay times ΔT, which in the example given here lie within the difference of 625 ns. This prolonging and/or reducing of the switching period T₀ of the fundamental form by means of the randomly determined delay time reduces the signal components at odd-numbered multiples of the fundamental frequency f₀=40 kHz in accordance with the object of the invention.

A random generator 24 (FIG. 1) is used to generate the sequence of randomly determined delay times ΔT. This is preferably implemented as a pseudorandom generator on a microprocessor in the control unit 22, the realization taking place by means of a feedback shift register or several combined feedback shift registers.

With an assumed fluctuation range of the switching frequency fₛ (=f₀) of 35 kHz to 45 kHz, this results in a time difference between the shortest and longest switching period Tᵢ of 1/35 kHz- 1/45 kHz=6.35 μs. With a program implementation as a feedback shift register having a period length of 1000, 1000 different randomly determined delay times ΔT having values between 0 kHz and 6.35 μs are therefore possible.

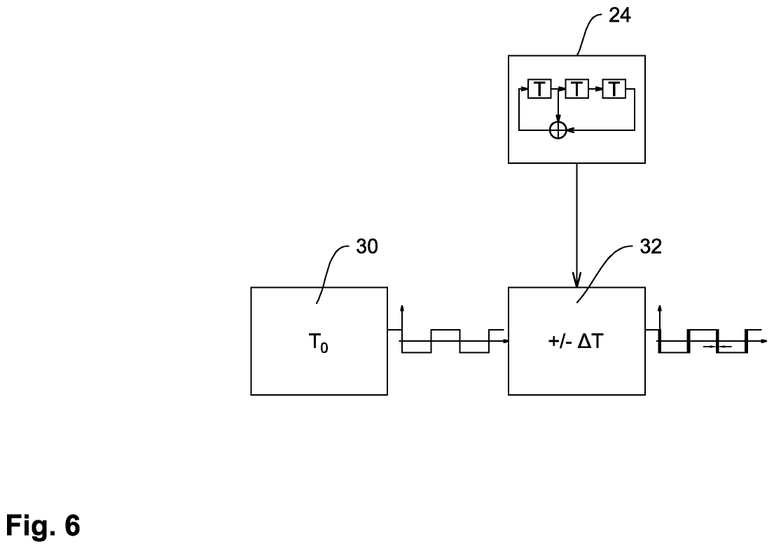

The switching frequency fₛ can be preset starting from a fundamental clock having the largest switching frequency fₛ=45 kHz and the corresponding period 22.22 μs by means of a base timer 30. The variation of the switching frequency fₛ by means of a dynamic delay timer 32 controlled by the pseudorandom generator 24 takes place at each switching period T₀, Tᵢ by adding the current randomly determined delay time (FIG. 6).

Similarly, a randomly determined, corresponding delay time ΔT can be added and subtracted from an average value of the switching frequency fₛ (positive or negative delay time ΔT).

Alternatively, it is also possible to assign a switching period Tᵢ corresponding to the changed switching frequency fₛ directly to the base timer 30 for each switching period T₀, Tᵢ without using the delay timer 32.

Instead of the base timer 30 and the delay timer 32, a randomly controlled (rectangular-wave) signal generator 34 (FIG. 1) can also be used, which randomly varies the switching frequency fₛ in a range around the fundamental frequency f₀. Preferably, the randomly controlled signal generator 34 is to be implemented in the control unit 22 on the basis of the DDS method, which is available as an IC module.

1. A method for suppressing EMC disturbances in a DC charging station (2) for electric vehicles (8), the DC charging station (2) having at least one converter circuit (10, 14) having semiconductor circuit breakers (20) which are actuated via a pulse curve using a switching frequency (fₛ), the method comprising the following steps:
providing an alternating voltage from an AC power supply system (4);
rectifying the alternating voltage in a DC intermediate voltage (12);
converting the DC intermediate voltage (12) to a DC charging voltage (6),
wherein the switching frequency (fₛ) of the pulse curve (30, 40) is varied continuously or randomly for actuating the semiconductor circuit breakers (20).

2. The method according to claim 1, wherein the switching frequency (fₛ) is varied via prolonging or reducing consecutive switching periods (T₀, Tᵢ) by a randomly determined delay time (ΔT).

3. The method according to claim 2, wherein the randomly determined delay time (ΔT) for prolonging or reducing the switching period (T₀) is generated via a random generator.

4. The method according to claim 3, wherein the random generator (24) is realized as a pseudorandom generator.

5. The method according to claim 1, wherein the switching frequency (fₛ) is varied by means of a digital signal generator (34).

6. The method according to claim 5, wherein the digital signal generator (34) functions on the basis of the DDS method.

7. An application of the method according to claim 6 in an analogous manner for a charging device in an electric vehicle (8), the charging device having at least one converter circuit (10, 14) having semiconductor circuit breakers (20) which are actuated via a pulse curve using a switching frequency (fₛ).
